(19) United States
(12) Patent Application Publication
(10) Pub. No.: US 2009/0123863 A1
(43) Pub. Date: May 14, 2009

(54) METHOD FOR PRODUCING A TONER FOR ELECTROSTATIC IMAGE DEVELOPMENT

(75) Inventors: Takeshi ASHIZAWA, Wakayama-shi (JP); Akihiro Eida, Wakayama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KAO CORPORATION, Chuo-ku (JP)

(21) Appl. No.: 12/264,555

(22) Filed: Nov. 4, 2008

(30) Foreign Application Priority Data
Nov. 8, 2007 (JP) 2007-290859

(51) Int. Cl. G03G 9/087; G03G 9/00

(52) U.S. Cl. 430/109.4; 430/137.1; 430/137.18

(57) ABSTRACT

A method for producing a toner for electrostatic image development, including the steps of melt-kneading a resin binder containing a crystalline polyester and an amorphous resin as main components, and heat-treating the melt-kneaded product obtained in the step of melt-kneading at a temperature of from 50° to 80° C., wherein the crystalline polyester is obtained by a polycondensation reaction of an α,ω-linear alkanediol and an aliphatic dicarboxylic acid compound, has the specified values of properties, and further is contained in an amount of from 1 to 35% by weight of the resin binder. The toner for electrostatic image development obtained by the present invention is suitably used for, for example, developing a latent image formed in electrophotography, electrostatic recording method, electrostatic printing method, or the like.

### FIELD OF THE INVENTION

The present invention relates to a method for producing a toner for electrostatic image development, used for, for example, developing a latent image formed in electrophotography, electrostatic recording method, electrostatic printing method, or the like, and a toner for electrostatic image development obtained by the method.

### BACKGROUND OF THE INVENTION

JP-A-2005-308995 discloses a method for producing a toner having improved low-temperature fixing ability, pulverizability, and storage property, including the steps of melt-kneading a crystalline polyester and an amorphous polyester and heat-treating the melt-kneaded product at specified temperature and time.

JP-A-2007-72333 discloses a toner having improved low-temperature fixing ability, heat-resistant storage property, or the like, including the steps of melt-kneading a toner composition containing a resin binder, a colorant, and a releasing agent and heat-treating the melt-kneaded product, thereby raising the temperature of the highest temperature of endothermic peak of the melt-kneaded product by a specified temperature after the heat treatment, the highest temperature of endothermic peak being in the range of from 40° to 75° C. as determined with a differential scanning calorimeter.

### SUMMARY OF THE INVENTION

The present invention relates to:
[1] a method for producing a toner for electrostatic image development, including the steps of melt-kneading a resin binder containing a crystalline polyester and an amorphous resin as main components, and heat-treating the melt-kneaded product obtained in the step of melt-kneading at a temperature of from 50° to 80° C., wherein the crystalline polyester satisfies the following (A) to (C):
(A) the crystalline polyester has

a number-average molecular weight (Mn) of from 5,000 to 10,000,

a weight-average molecular weight (Mw) of from 40,000 to 150,000,

a highest temperature of endothermic peak determined with a differential scanning calorimeter of from 100° to 140° C., and

a ratio of the softening point to the highest temperature of the endothermic peak, i.e., softening point/highest temperature of endothermic peak, of from 0.8 to 1.2,
(B) the crystalline polyester is contained in an amount of from 1 to 35% by weight of the resin binder, and
(C) the crystalline polyester is a polycondensed product of an α,ω-linear alkanediol and an aliphatic dicarboxylic acid compound; and
[2] a toner for electrostatic image development obtained by the method as defined in the above [1].

### BRIEF DESCRIPTION OF THE DRAWINGS

FIG. 1 is a chart of one example showing a peak ascribed to crystal melting in the determination with a differential scanning calorimeter, wherein a shaded area shows the endothermic amount required for the crystal melting.

FIG. 2 is a graph showing the relationship between the crystalline polyester content in the resin binder (% by weight) and the crystallization ratio (%) of the melt-kneaded product after the heat treatment, in the toners of Examples 1 to 6 and Comparative Examples 2, 3, and 5 to 7.

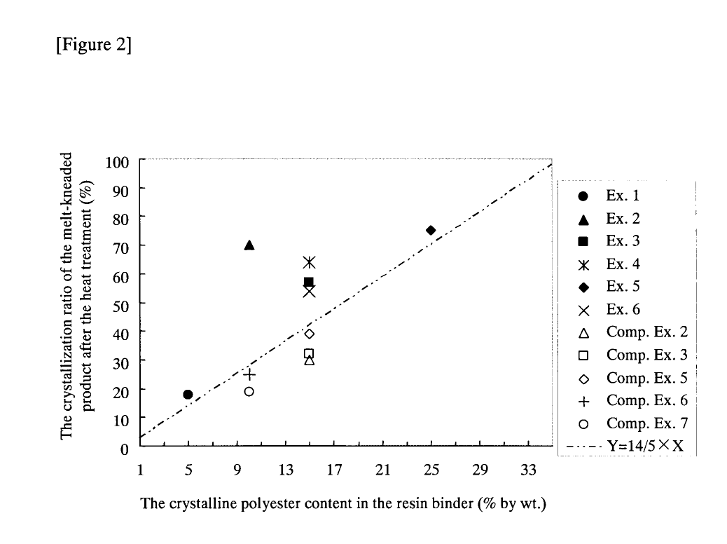

### DETAILED DESCRIPTION OF THE INVENTION

The present invention relates to a method for producing a toner for electrostatic image development, in which a crystalline polyester and an amorphous resin are used together, the toner having a wide fixing temperature range and additionally being excellent in thermal durability (hereinafter simply referred to as “durability”); and a toner for electrostatic image development obtained by the method.

According to the method of the present invention, a toner for electrostatic image development, in which a crystalline polyester and an amorphous resin are used together, the toner having a wide fixing temperature range and also being excellent in durability can be obtained.

These and other advantages of the present invention will be apparent from the following description.

A toner in which a crystalline polyester and an amorphous polyester are used together has improved low-temperature fixing ability; however, in another aspect, the toner is likely to cause fusion to a charging blade, a photoconductor and the like, during printing, leading to a disadvantage in durability during continuous printing.

In addition, with the advancement in speeding-up and voluminous development of an electrostatic image development device, thermal durability of a toner is insufficient according to techniques disclosed in JP-A-2005-308995 and JP-A-2007-72333.

Therefore, as a result of intensive studies in order to obtain a toner having excellent fixing ability and durability even when a crystalline polyester and an amorphous polyester are used together, the present inventors have found that a toner for electrostatic image development having a wide fixing temperature range and additionally being excellent in durability is obtained by melt-kneading raw materials of the toner containing a resin binder in which a crystalline polyester having a large molecular weight in a specified amount is used together with an amorphous resin, and heat-treating the kneaded product. The present invention has been accomplished thereby.

The present invention relates to a method for producing a toner for electrostatic image development, including the steps of melt-kneading a resin binder containing a crystalline polyester and an amorphous resin as main components, and heat-treating the melt-kneaded product obtained in the step of melt-kneading, and one of the significant features of the present invention resides in that the resin binder contains a crystalline polyester having a specified molecular weight, in a specified amount. Here, the term “crystallization ratio” in the present specification is a value defined in a method of determining “crystallization ratio” set forth below, and it is considered that “crystallization ratio” means a proportion of a crystalline part in a system containing a melt-kneaded product or the like, based on a proportion of a crystalline part in the crystalline polyester used. In addition, the term “main component” as used herein refers to a component contained in an amount of 95% by weight or more of the resin binder. The term “heat-treating” as used herein refers to a process of treating at a temperature between 50° C. or higher and a temperature equal to or lower than a melting point of the crystalline polyester, specifically, for example, at a temperature of from 50° to 80° C. Specifically, when two or more kinds of crystalline polyesters are used, the term “heat-treating” refers to a process of treating at a temperature between 50° C. or higher and a temperature equal to or lower than a melting point of a crystalline polyester having the lowest melting point.

In the present invention, a resin binder containing a crystalline polyester having a specified molecular weight, in a specified amount, is heat-treated, from the viewpoint of improving thermal durability (hereinafter also simply referred to as “durability”). Generally, the step of heat-treating has effects of forming a phase separation structure of the crystalline polyester and the amorphous resin and stabilizing individual resins, thereby sufficiently exhibiting properties of each of the resins. In the present invention, although not wanting to be limited by theory, it is presumed that in a case where a crystalline polyester in a melt-kneaded product to be heat-treated is contained in a specified amount, the above phase separation structure can be stably formed, and that in a case where the crystalline polyester content in a melt-kneaded product to be heat-treated and the crystallization ratio of the melt-kneaded product after the heat treatment satisfy a certain relationship, a part constituted by a polyester having crystallinity can be allowed to be present in a specified embodiment in the above phase separation structure, and thermal stability is more improved, so that a toner being more excellent in durability is obtained. Further, it is presumed that in a case where the crystalline polyester used has a specified molecular weight, the effect is more remarkably exhibited, and the effect of improving durability can be more enhanced while securing a wide fixing temperature range.

The step of melt-kneading of the method of the present invention includes the step of melt-kneading a resin binder containing a crystalline polyester and an amorphous resin as main components.

The crystallinity of the resin is expressed as a ratio of a softening point to a highest temperature of endothermic peak determined with a differential scanning calorimeter, i.e., softening point/highest temperature of endothermic peak. Generally, when the above-mentioned value exceeds 1.5, the resin is amorphous; and when the value is less than 0.6, the resin is low in crystallinity and mostly amorphous. The crystallinity of the resin can be adjusted by the kinds of the raw material monomers and a ratio thereof, production conditions (for example, reaction temperature, reaction time, and cooling rate), and the like. In the present invention, the term “crystalline polyester” refers to a polyester having a ratio of softening point/highest temperature of endothermic peak of from 0.6 to 1.5, and preferably from 0.8 to 1.2, and the term “amorphous resin” refers to a resin having a ratio of softening point/highest temperature of endothermic peak, of more than 1.5, or less than 0.6, and preferably more than 1.5. Here, the highest temperature of endothermic peak refers to a temperature of the peak on the highest temperature side among endothermic peaks observed. When a difference between the highest temperature of endothermic peak and the softening point is within 20° C., the highest temperature of endothermic peak is defined as a melting point. When the difference between the highest temperature of endothermic peak and the softening point exceeds 20° C., the peak is ascribed to a glass transition.

The crystalline polyester in the present invention is obtained by polycondensing an α,ω-linear alkanediol and an aliphatic dicarboxylic acid compound.

The α,ω-linear alkanediol includes ethylene glycol, 1,3-propylene glycol, 1,4-butanediol, 1,5-pentanediol, 1,6-hexanediol, and the like. Among them, 1,4-butenediol and 1,6-hexanediol are preferable.

The aliphatic dicarboxylic acid compound includes aliphatic dicarboxylic acids such as oxalic acid, malonic acid, maleic acid, fumaric acid, citraconic acid, itaconic acid, glutaconic acid, succinic acid, adipic acid, sebacic acid, azelaic acid, n-dodecylsuccinic acid, and n-dodecenylsuccinic acid; acid anhydrides thereof, alkyl(1 to 3 carbon atoms) esters thereof; and the like. Among them, fumaric acid is preferable. Here, the aliphatic dicarboxylic acid compound refers to aliphatic dicarboxylic acids, anhydrides thereof, and alkyl(1 to 3 carbon atoms) ester thereof, as mentioned above. Among them, the aliphatic dicarboxylic acids are preferable.

The molar ratio of the aliphatic dicarboxylic acid compound to the α,ω-linear alkanediol in the crystalline polyester in the present invention, i.e., aliphatic dicarboxylic acid compound/α,ω-linear alkanediol, is preferably from 0.9 or more and less than 1.0, and more preferably from 0.95 or more and less than 1.0, from the viewpoint of production stability, and further from the viewpoint of being capable of easily adjusting the molecular weight of the resin by evaporation during a vacuum reaction in a case where the α,ω-linear alkanediol is contained in a large amount.

The polycondensation of the α,ω-linear alkanediol and the aliphatic dicarboxylic acid compound can be carried out by reacting the components in an inert gas atmosphere at a temperature of from 120° to 230° C., optionally using an esterification catalyst, a polymerization inhibitor, and the like, or the like. Specifically, a method including the step of charging an entire monomer at once in order to increase the strength of the resin, or alternatively including the step of firstly reacting divalent monomers, and thereafter adding and reacting trivalent or higher polyvalent monomers in order to reduce low-molecular weight components, or the like may be employed. In addition, the reaction may be accelerated by reducing a pressure of the reaction system in the latter half of the polymerization.

The esterification catalyst is present in the reaction system in an amount of preferably from 0.03 to 1 part by weight, and more preferably from 0.05 to 0.8 parts by weight, based on 100 parts by weight of the total amount of the α,ω-linear alkanediol and the aliphatic dicarboxylic acid compound.

The number-average molecular weight (Mn) of the crystalline polyester has an adverse effect each on storage property of the toner when it is too low, and on productivity of the toner when it is too high. Therefore, the crystalline polyester has a number-average molecular weight of from 5,000 to 10,000, and preferably from 6,000 to 9,000. In the present specification, the number-average molecular weight (Mn) and weight-average molecular weight (Mw) of the resin are determined according to the methods described in Examples set forth below. The method of adjusting the number-average molecular weight includes, for example, a method of adjusting the molar ratio of the aliphatic dicarboxylic acid compound to the α,ω-linear alkanediol, and a method of adjusting the reaction conditions for esterification, such as the reaction temperature, the amount of a catalyst, and subjecting to a dehydration reaction for a long time under a reduced pressure. Specifically, the number-average molecular weight can be increased by increasing the ratio of the aliphatic dicarboxylic acid compound, or raising the reaction temperature, increasing the amount of a catalyst, extending the time period of the dehydration reaction, or the like. In addition, in a case of carrying out a process conversely to that described above, the number-average molecular weight is likely to be smaller.

In addition, it is preferable that the crystalline polyester contains high-molecular weight component in a certain amount, from the viewpoint of durability of the toner; therefore, the crystalline polyester has a weight-average molecular weight (Mw) of from 40,000 to 150,000, and preferably from 50,000 to 120,000. The crystalline polyester has a ratio of the weight-average molecular weight (Mw) to the number-average molecular weight (Mn), i.e., Mw/Mn, of preferably from 5 to 20, more preferably from 6 to 18, and even more preferably from 8 to 15, from the viewpoint of durability of the toner. The method of adjusting the weight-average molecular weight includes methods similar to those for the method of adjusting the number-average molecular weight as described above.

The crystalline polyester has a highest temperature of endothermic peak determined with a differential scanning calorimeter of from 100° to 140° C., preferably from 110° to 140° C., more preferably from 110° to 130° C., and even more preferably from 110° to 120° C., from the viewpoint of fixing ability, storage property and durability of the toner. In the present specification, the highest temperature of endothermic peak is determined according to the method described in Examples set forth below. The method for adjusting the highest temperature of endothermic peak includes, for example, a method of adjusting the number-average molecular weight. When the number-average molecular weight is larger, the highest temperature of endothermic peak is likely to be higher, and when the number-average molecular weight is smaller, the highest temperature of endothermic peak is likely to be lower.

The crystalline polyester has a softening point of preferably from 70° to 140° C., more preferably from 90° to 130° C., even more preferably from 90° to 110° C., and even more preferably from 90° to 100° C., from the viewpoint of low-temperature fixing ability of the toner. In the present specification, the softening point is determined according to the method described in Examples set forth below. The method of adjusting the softening point includes, for example, a method of adjusting the molar ratio of the aliphatic dicarboxylic acid compound to the α,ω-linear alkanediol, and a method of varying the reaction conditions of esterification, such as the reaction temperature, the amount of a catalyst, and subjection to a dehydration reaction for a long period of time under a reduced pressure. Specifically, the number-average molecular weight can be enlarged by increasing the ratio of the aliphatic dicarboxylic acid compound, or raising the reaction temperature, increasing the amount of a catalyst, extending the time period of the dehydration reaction, or the like. In addition, in a case of carrying out a process conversely to that described above, the number-average molecular weight is likely to be smaller. Further, as described above, the adjustment of the ratio of the softening point to the highest temperature of endothermic peak can be accomplished by adjusting the molar ratio of the aliphatic dicarboxylic acid compound to the α,ω-linear alkanediol, or adjusting the reaction conditions, such as raising the reaction temperature, increasing the amount of a catalyst, or subjecting to a dehydration reaction for a long period of time under a reduced pressure.

The amorphous resin in the present invention is preferably one obtained by polycondensing an alcohol component containing an alkylene oxide adduct of bisphenol A and a carboxylic acid component containing an aromatic carboxylic acid compound having an aromatic ring. For example, an amorphous polyester is exemplified.

The alcohol component contains an alkylene oxide adduct of bisphenol A represented by the formula (I):

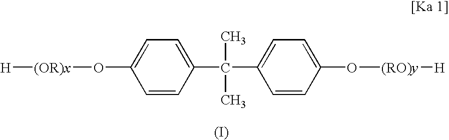

wherein RO is an oxyalkylene group, wherein R is an ethylene and/or propylene group; and each of x and y is a positive number showing an average number of moles of alkylene oxide added, wherein the sum of x and y on average is preferably from 1 to 16, more preferably from 1 to 8, and even more preferably from 1.5 to 4,
in an amount of preferably from 90 to 100% by mol, more preferably from 95 to 100% by mol, and even more preferably substantially 100% by mol, of the alcohol component. Incidentally, in the present specification, when the resin binder contains two or more kinds of the amorphous resins, the content of the alkylene oxide adduct of bisphenol A in the alcohol component means the weighed average content, and it is desired that the weighed average content is within the above-mentioned ranges.

The alkylene oxide adduct of bisphenol A represented by the formula (I) includes an alkylene(2 to 3 carbon atoms) oxide(average number of moles: 1 to 16) adduct of bisphenol A such as polyoxypropylene-2,2-bis(4-hydroxyphenyl)propane and polyoxyethylene-2,2-bis(4-hydroxyphenyl)propane, and the like.

An alcohol component other than the alkylene oxide adduct of bisphenol A includes ethylene glycol, 1,2-propylene glycol, 1,4-butanediol, neopentyl glycol, polyethylene glycol, polypropylene glycol, bisphenol A, hydrogenated bisphenol A, sorbitol, pentaerythritol, glycerol, trimethylolpropane, and the like.

As the carboxylic acid component, a dicarboxylic acid compound containing an aliphatic dicarboxylic acid compound exemplified as the raw material of the above-mentioned crystalline polyester, such as fumaric acid, or an aromatic carboxylic acid compound having an aromatic ring, can be used. The aromatic carboxylic acid compound having an aromatic ring is contained in an amount of preferably from 50% by mol or more, and more preferably from 90 to 100% by mol, even more preferably from 95 to 100% by mol, and even more preferably substantially 100% by mol, of the carboxylic acid component, from the viewpoint of maintaining a high crystallization ratio of the melt-kneaded product due to its rigid structure. Incidentally, in the present specification, when the resin binder contains two or more kinds of the amorphous resins, the content of the aromatic carboxylic acid compound in the carboxylic acid component means the weighed average content, and it is desired that the weighed average content is within the above-mentioned ranges.

The aromatic carboxylic acid compound includes aromatic dicarboxylic acids such as phthalic acid, isophthalic acid, and terephthalic acid; aromatic tricarboxylic or higher carboxylic acid compounds such as 1,2,4-benzenetricarboxylic acid (trimellitic acid), 2,5,7-naphthalenetricarboxylic acid, and pyromellitic acid; carboxylic acid compounds such as acid anhydrides thereof, and alkyl(1 to 3 carbon atoms) esters thereof; and the like. Among them, terephthalic acid is preferable from the viewpoint of environmental stability and durability.

The carboxylic acid component other than the aromatic carboxylic acid compound includes aliphatic dicarboxylic acids, such as oxalic acid, malonic acid, maleic acid, fumaric acid, citraconic acid, itaconic acid, glutaconic acid, succinic acid, adipic acid, sebacic acid, azelaic acid, n-dodecylsuccinic acid, and n-dodecenylsuccinic acid; alicyclic dicarboxylic acids such as cyclohexanedicarboxylic acid; acid anhydrides of these acids, and alkyl(1 to 3 carbon atoms) esters of these acids; and the like. The acids, anhydrides of these acids, and alkyl esters of the acids as mentioned above are collectively referred to herein as a carboxylic acid compound.

Here, the alcohol component may properly contain a monohydric alcohol, and the carboxylic acid component may properly contain a monocarboxylic acid compound, from the viewpoint of adjustment of the molecular weight and improvement in offset resistance.

The polycondensation of the alcohol component and the carboxylic acid component in the amorphous resin can be carried out, for example, in an inert gas atmosphere at a temperature of from 180° to 250° C., and it is preferable that the polycondensation is carried out in the presence of an esterification catalyst, for example, tin octylate, from the viewpoint of more remarkably exhibiting the effects of the present invention.

The esterification catalyst is present in the reaction system in an amount of preferably from 0.05 to 1 part by weight, and more preferably from 0.1 to 0.8 parts by weight, based on 100 parts by weight of the total amount of the alcohol component and the carboxylic acid component.

In addition, in the present invention, it is preferable that the amorphous resin contains two different kinds of amorphous polyesters of which softening points differ by preferably 10° C. or more, and more preferably 10° to 60° C., from the viewpoint of low-temperature fixing ability and offset resistance of the toner. The low-softening point polyester has a softening point of preferably from 80° to 120° C., and more preferably from 90° to 120° C., from the viewpoint of low-temperature fixing ability of the toner. The high-softening point polyester has a softening point of preferably from 120° to 150° C., and more preferably from 120° to 140° C., from the viewpoint of offset resistance. Here, when the amorphous resin is composed of three or more kinds of resins, it is preferable that the two kinds of resins contained in larger amounts satisfy the above. For example, when the second and third resins in descending order are contained in the same amount, it is preferable that the resin contained in a largest amount and either of the second resins satisfy the above.

The weight ratio of the high-softening point polyester to the low-softening point polyester, i.e., high-softening point polyester/low-softening point polyester, is preferably from 1/9 to 9/1, and more preferably from 2/8 to 8/2. In addition, in order to further improve durability of the toner, high-softening point polyester/low-softening point polyester is preferably from 8/2 to 5/5, and in order to further improve low-temperature fixing ability of the toner, high-softening point polyester/low-softening point polyester is preferably from 4/6 to 2/8.

When the amorphous resin contains two or more amorphous polyesters, the amorphous resin has an average softening point of preferably from 100° to 140° C., and more preferably from 110° to 130° C., from the viewpoint of low-temperature fixing ability of the toner. In the present specification, an average softening point refers to a weighed average softening point. Each softening point is determined according to the method described in Examples set forth below.

The amorphous resin has a glass transition temperature of preferably from 40° to 70° C., and more preferably from 50° to 70° C., from the viewpoint of low-temperature fixing ability and durability of the toner. The amorphous resin has an acid value of preferably from 5 to 25 mgKOH/g, and more preferably from 5 to 20 mgKOH/g. In the present specification, the glass transition temperature and the acid value are determined according to the methods described in Examples set forth below.

In the present invention, the amorphous resin may be a polyester that has been modified to an extent that the polyester does not substantially impair the properties. The modified polyester includes a polyester grafted or blocked with phenol, urethane, epoxy, or the like, according to a method described in JP-A-Hei-11-133668, JP-A-Hei-10-239903, JP-A-Hei-8-20636, or the like, and a composite resin having two or more kinds of resin units including a polyester unit.

In the present invention, the resin binder contains the crystalline polyester and the amorphous resin as main components, and the crystalline polyester is contained in an amount of from 1 to 35% by weight, preferably from 5 to 35% by weight, and more preferably from 15 to 30% by weight, of the resin binder, from the viewpoint of low-temperature fixing ability and durability of the toner.

The amorphous resin is contained in a total amount of preferably from 65 to 99% by weight, more preferably from 65 to 95% by weight, and even more preferably from 70 to 85% by weight, of the resin binder, from the viewpoint of low-temperature fixing ability and durability of the toner.

The weight ratio of the crystalline polyester to the amorphous resin, i.e., crystalline polyester/amorphous resin, is preferably from 5/95 to 35/65, and more preferably from 15/85 to 30/70, from the viewpoint of low-temperature fixing ability and durability of the toner.

Besides the crystalline polyester and the amorphous resin, the resin binder in the present invention may properly contain other resin binders within the range which would not impair the effects of the present invention. Other resin binders include resin binders other than polyesters, such as vinyl resins, epoxy resins, polycarbonates, and polyurethanes, and the like. The crystalline polyester and the amorphous polyester are contained in a total amount of preferably 95% by weight or more, and more preferably 99% by weight or more, of the resin binder, from the viewpoint of low-temperature fixing ability of the toner, but not particularly limited thereto.

As the raw materials of the toner in the present invention other than the resin binder, an additive such as a colorant, a releasing agent, a charge control agent, a magnetic powder, an electric conductivity modifier, an extender pigment, a reinforcing filler such as a fibrous material, an antioxidant, an anti-aging agent, a fluidity improver, or a cleanability improver may be further properly used.

As the colorant, all of the dyes, pigments and the like which are used as colorants for toners can be used, and carbon blacks, Phthalocyanine Blue, Permanent Brown FG, Brilliant Fast Scarlet, Pigment Green B, Rhodamine-B Base, Solvent Red 49, Solvent Red 146, Solvent Blue 35, quinacridone, carmine 6B, isoindoline, disazoyellow, or the like can be used. These colorants can be used alone or in admixture of two or more kinds. The toner of the present invention may be any of black toner, color toner, and full-color toner. The colorant is contained in an amount of preferably from 1 to 40 parts by weight, and more preferably from 3 to 10 parts by weight, based on 100 parts by weight of the resin binder.

The releasing agent includes waxes such as synthetic waxes such as polypropylene wax, polyethylene wax, and Fischer-Tropsch wax; coal waxes such as montan wax; petroleum waxes such as paraffin waxes; and alcohol waxes; and natural ester-based waxes such as carnauba wax and rice wax. These waxes may be used alone or in admixture of two or more kinds. The releasing agent is contained in an amount of preferably from 1 to 20 parts by weight, and more preferably from 2 to 10 parts by weight, based on 100 parts by weight of the resin binder, from the viewpoint of fixing ability.

The charge control agent may be either a positively chargeable charge control agent or a negatively chargeable charge control agent. Also, a positively chargeable charge control agent and a negatively chargeable charge control agent may be used together. The positively chargeable charge control agent includes Nigrosine dyes, triphenylmethane-based dyes containing a tertiary amine as a side chain, quaternary ammonium salt compounds, polyamine resins, imidazole derivatives, and the like. The negatively chargeable charge control agent includes metal-containing azo dyes, copper phthalocyanine dyes, metal complexes of alkyl derivatives of salicylic acid, boron complexes of benzilic acid, and the like. The charge control agent is contained in an amount of preferably from 0.1 to 5.0 parts by weight, and more preferably from 0.2 to 4.0 parts by weight, based on 100 parts by weight of the resin binder.

In the melt-kneading, it is preferable that the raw materials of the toner such as the resin binder are homogenously mixed and thereafter melt-kneaded. The mixing of the raw materials of the toner may be either a method of mixing all the raw materials such as the resin binder at one time or a method of dividing the raw materials and mixing.

A mixer used for mixing the raw materials of the toner includes a Henschel mixer, a Super mixer, and the like. A Henschel mixer is preferable from the viewpoint of dispersibility.

The melt-kneading of the raw materials of the toner can be carried out using a known kneader such as a closed kneader, a single-screw or twin-screw extruder, or a continuous open-roller type kneader. Since the additive can be efficiently highly dispersed in the resin binder without repeating the kneading step or without a dispersion aid, it is preferable to use a continuous open-roller type kneader provided with feeding ports and a discharging outlet for a kneaded product arranged along an axial direction of the roller.

The mixture of the raw materials of the toner may be fed to the kneader from one feeding port and may be divided and fed to the kneader from plural feeding ports. It is preferable that the raw materials of the toner are fed to the kneader from one feeding port, from the viewpoint of easiness of operation and simplification of an apparatus.

The continuous open-roller type kneader refers to a kneader of which melt-kneading member is an open type, and can easily dissipate the kneading heat generated during the melt-kneading. In addition, it is desired that the continuous open-roller type kneader is a kneader provided with at least two rollers. The continuous open-roller type kneader used in the present invention is a kneader provided with two rollers having different peripheral speeds, in other words, two rollers of a high-rotation side roller having a high peripheral speed and a low-rotation side roller having a low peripheral speed. In the present invention, it is desired that the high-rotation side roller is a heat roller, and the low-rotation side roller is a cooling roller, from the viewpoint of dispersibility.

The temperature of the roller can be adjusted by, for example, a temperature of a heating medium passing through the inner portion of the roller, and each roller may be divided in two or more portions in the inner portion of the roller, each being communicated with heating media of different temperatures.

The temperature at the end part of the raw material supplying side of the high-rotation side roller is preferably from 100° to 160° C., and the temperature at the end part of the raw material supplying side of the low-rotation side roller is preferably from 35° to 100° C.

In the high-rotation side roller, the difference between a setting temperature at the end part of the raw material supplying side and a setting temperature at the end part of the kneaded product discharging side is preferably from 20° to 60° C., more preferably from 20° to 50° C., and even more preferably from 30° to 50° C., from the viewpoint of preventing detachment of the kneaded product from the roller. In the low-rotation side roller, the difference between a setting temperature at the end part of the raw material supplying side and a setting temperature at the end part of the kneaded product discharging side is preferably from 0° to 50° C., more preferably from 0° to 40° C., and even more preferably from 0° to 20° C., from the viewpoint of dispersibility of the releasing agent.

The peripheral speed of the high-rotation side roller is preferably from 2 to 100 m/min, and more preferably from 4 to 50 m/min. The peripheral speed of the low-rotation side roller is preferably from 1 to 90 m/min, more preferably from 2 to 60 m/min, and even more preferably from 2 to 50 m/min. In addition, the ratio between the peripheral speeds of the two rollers, i.e., low-rotation side roller/high-rotation side roller, is preferably from 1/10 to 9/10, and more preferably from 3/10 to 8/10.

Structures, size, materials and the like of the roller are not particularly limited. Also, the surface of the roller may be any of smooth, wavy, rugged, or other surfaces. In order to increase kneading share, it is preferable that plural spiral ditches are engraved on the surface of each roller.

Thus, the melt-kneaded product of the raw materials of the toner containing the resin binder containing the crystalline polyester and the amorphous resin is obtained.

The melt-kneaded product obtained above can be used for a pulverized toner obtained by pulverizing the melt-kneaded product, or a polymerization toner obtained by dispersing the melt-kneaded product as particles in a solvent. Since the present invention does not include a step of heat-treating other than the step of heat-treating after the step of melt-kneading, it is preferable to use the melt-kneaded product for the production of the pulverized toner.

In a general method for producing a pulverized toner, the resulting melt-kneaded product is cooled to a pulverizable hardness, and the cooled melt-kneaded product is subjected to a pulverization step. In the present invention, it is preferable that after the step of melt-kneading, the resulting melt-kneaded product is subjected to a step of heat-treating, and thereafter subjected to a pulverization step.

In the present invention, it is desired that the step of heat-treating is carried out at a temperature of 50° to 80° C., and preferably from 50° to 70° C., for preferably 3 to 80 hours, and more preferably 3 to 72 hours, from the viewpoint of maintaining dispersion of a toner additive and having rearrangement property of a resin binder molecule, thereby improving durability of the toner. Here, the above time period is a cumulative time in which the temperature falls within the above range. In addition, it is preferable that the temperature does not surpass the upper limit of the above range from the beginning to the end of the step of heat-treating from the viewpoint of maintaining dispersion of a toner additive and having rearrangement property of a resin binder molecule.

In the present invention, although not wanting to be limited by theory, it is presumed that rearrangement of a resin in the melt-kneaded product is accelerated by carrying out the step of heat-treating at the above-mentioned temperature for the above-mentioned time period, and durability of the toner is improved by the recovery of a glass transition temperature which is once lowered. Further, a plastic part, in other words, a part having a low-glass transition temperature is more likely to absorb impact during the pulverization, thereby causing lowering of the pulverization efficiency. In the present invention, since plasticization is controlled in the step of heat-treating before the pulverization step, the pulverizability can also be improved.

In the step of heat-treating, an oven or the like can be used. For example, when an oven is used, the step of heat-treating can be carried out by keeping a melt-kneaded product in the oven kept at a fixed temperature.

Embodiments for carrying out the step of heat-treating are not particularly limited. For example, embodiments include:
Embodiment 1: An embodiment including the steps of, when cooling a melt-kneaded product after the step of melt-kneading, keeping the melt-kneaded product under the heat treatment conditions mentioned above, subsequently cooling the melt-kneaded product to a pulverizable hardness, and subjecting the cooled product to a subsequent step such as a pulverization step.
Embodiment 2: An embodiment including the steps of once cooling a melt-kneaded product after the step of melt-kneading to a pulverizable hardness, subjecting the cooled melt-kneaded product to the above-mentioned step of heat-treating, subsequently cooling the melt-kneaded product again, and subjecting the cooled product to a subsequent step such as a pulverization step. In the present invention, the step of heat-treating may be carried out by either embodiment, and the embodiment 2 is preferable from the viewpoint of dispersibility of an additive in the toner. At this time, the temperature at which the melt-kneaded product is cooled to a pulverizable hardness includes, for example, a temperature of preferably lower than 50° C., more preferably 40° C. or lower, and even more preferably 35° C. or lower.

With an increased content of the crystalline polyester in the resin binder, the crystallization ratio of the melt-kneaded product is likely to increase. However, a portion which does not have a crystalline structure, in other words, a portion not crystallized upon the melt-kneading is also present in the crystalline polyester. When the portion is present in a large amount in the melt-kneaded product, the melt-kneaded product tends to be poor in durability. Therefore, crystallization in the entire melt-kneaded product is accelerated by the step of heat-treating to increase the crystallization ratio, thereby durability is improved.

Thus, the heat-treated product of the melt-kneaded product is obtained. It is preferable that the crystallization ratio Y of the melt-kneaded product after the step of heat-treating is greater than the crystallization ratio of the melt-kneaded product before the heat treatment, from the viewpoint of durability. Also, it is desired that Y and the content of the crystalline polyester in the resin binder X (% by weight) satisfy the following relationships:

preferably 14/5×X≦Y

more preferably 16/5×X≦Y, and

even more preferably 7/2×X≦Y,

with the proviso that the upper limit of Y is 100.

In the pulverized toner, the heat-treated product after the step of heat-treating is cooled to a pulverizable hardness, and thereafter the cooled product is subjected to a pulverization step and a classifying step.

The pulverization step may be carried out in divided multi-stages. For example, the heat-treated product after the step of heat-treating may be roughly pulverized to a size of from 1 to 5 mm or so, and thereafter further finely pulverized to a desired particle size.

The pulverizer used in the pulverization step is not particularly limited. For example, the pulverizer suitably used in the rough pulverization includes an atomizer, Rotoplex, and the like, and the pulverizer suitably used in the fine pulverization includes a jet mill, an impact type jet mill, a rotary mechanical mill, and the like.

The classifier used in the classifying step includes an air classifier, a rotor type classifier, a sieve classifier, and the like. During the classifying step, the pulverized product which is insufficiently pulverized and removed may be subjected to the pulverization step again.

The toner is obtained through the above-mentioned steps. Further, fine inorganic particles such as hydrophobic silica, or fine resin particles may be externally added to the surface of the resulting toner.

The toner obtained by the present invention has a volume-median particle size (D₅₀) of preferably from 4.5 to 6.5 μm, and more preferably from 5.5 to 6 μm, from the viewpoint of image quality and chargeability. The term “volume-median particle size (D₅₀)” as used herein refers to a particle size of which cumulative volume frequency calculated on a volume percentage is 50% counted from the smaller particle sizes.

The toner obtained by the present invention can be used as any of a toner for monocomponent development and a toner for two-component development in which the toner mixed with a carrier is used, and the toner is more preferably used as a toner for monocomponent development for which heat resistance is more demanding.

### EXAMPLES

The following examples further describe and demonstrate embodiments of the present invention. The examples are given solely for the purposes of illustration and are not to be construed as limitations of the present invention.

### [Softening Point of Resin]

The softening point refers to a temperature at which a half the amount of the sample flows out when plotting a downward movement of a plunger against temperature, as measured by using a flow tester (CAPILLARY RHEOMETER “CFT-500D,” commercially available from Shimadzu Corporation), in which a 1 g sample is extruded through a nozzle having a diameter of 1 mm and a length of 1 mm while heating the sample so as to raise the temperature at a rate of 6° C./min and applying a load of 1.96 MPa thereto with the plunger.

### [Acid Value of Resin]

The acid value is determined by a method according to JIS K0070 except that only the determination solvent was changed from a mixed solvent of ethanol and ether as defined in JIS K0070 to a mixed solvent of acetone and toluene (volume ratio of acetone:toluene=1:1).

### [Highest Temperature of Endothermic Peak and Melting Point of Resin]

Using a differential scanning calorimeter (“Q-100,” commercially available from TA Instruments, Japan), the sample is cooled from room temperature to 0° C. at a cooling rate of 10° C./min and allowed to stand thereat for 1 minute, and thereafter the heat flow of the sample is determined at a heating rate of 50° C./min. Among the endothermic peaks observed, the temperature of an endothermic peak on the highest temperature side is defined as a highest temperature of endothermic peak. When a difference between the highest temperature of endothermic peak and the softening point is within 20° C., the peak temperature is defined as a melting point. When a difference between the highest temperature of endothermic peak and the softening exceeds 20° C., the peak is ascribed to glass transition.

### [Glass Transition Temperature of Resin]

Using a differential scanning calorimeter (“Q-100,” commercially available from TA Instruments, Japan), the sample is cooled from room temperature to 0° C. at a cooling rate of 10° C./min and allowed to stand thereat for 1 minute, and thereafter the heat flow of the sample is determined at a heating rate of 50° C./min. When a difference between the highest temperature of endothermic peak and the softening point is within 20° C., a temperature of an intersection of the extension of the baseline of equal to or lower than the highest temperature of endothermic peak and the tangential line showing the maximum inclination between the kick-off of the peak and the top of the peak is read as a glass transition temperature. When a difference between the highest temperature of endothermic peak and the softening point exceeds 20° C., a temperature of an intersection of the extension of the baseline of equal to or lower than the temperature of a peak observed at a temperature lower than the highest temperature of endothermic peak and the tangential line showing the maximum inclination between the kick-off of the peak and the top of the peak is read as a glass transition temperature.

### [Average Molecular Weight of Resin]

The number-average molecular weight and the weight-average molecular weight are obtained from a chart showing the molecular weight distribution determined by the gel permeation chromatography, obtained by the following method.

### (1) Preparation of Sample Solution

A resin is dissolved in chloroform, so as to have a concentration of 0.5 g/100 mL. The resulting solution is then filtered with a fluororesin filter (“FP-200,” commercially available from Sumitomo Electric Industries, Ltd.) having a pore size of 2 μm to remove insoluble components, to give a sample solution.

### (2) Determination of Molecular Weight Distribution

As an eluant, chloroform is allowed to flow at a rate of 1 mL/min using the following analyzer and column. The column is stabilized in a thermostat at 40° C. One-hundred microliters of the sample solution is injected to the column to determine the molecular weight distribution. The molecular weight of the sample is calculated on the basis of a calibration curve previously prepared. The calibration curve of the molecular weight is one prepared by using several kinds of monodisperse polystyrenes as standard samples.
Analyzer: CO-8010 (commercially available from Tosoh Corporation)
Column: GMHLX+G3000HXL (commercially available from Tosoh Corporation)

### [Crystallization Ratio]

Using a differential scanning calorimeter (“Q-100,” commercially available from TA Instruments, Japan), the sample is cooled from room temperature to 0° C. at a cooling rate of 10° C./min (about 10 mg) and allowed to stand thereat for 1 minute, and thereafter the heat flow of the sample is determined at a heating rate of 50° C./min to a temperature of 180° C. Subsequently, with regard to an endothermic peak ascribed to a crystal melting appearing at a temperature of from 90° to 120° C. on the resulting heat curve, a straight line connecting a point closest to a peak on the baseline at a temperature equal to or lower than the starting point of the peak to a point closest to a peak on the baseline at a temperature equal to or higher than the end point of the peak is drawn, thereby a peak area is calculated and defined as the endothermic amount required to the crystal melting. The melt-kneaded product and a raw material thereof, a crystalline polyester, are used as samples, an endothermic amount required to the crystal melting of the crystalline polyester is obtained, and an endothermic amount required to a crystal melting per the content of the crystalline polyester which is the raw material (% by weight) is calculated, thereby the crystallization ratio of the sample is calculated according to the following formula.

Crystallization Ratio(%)=Endothermic Amount of Melt-Kneaded Product/Endothermic Amount Per Content of Crystalline Polyester Which Is Raw Material of Melt-Kneaded Product(% by Weight)×100

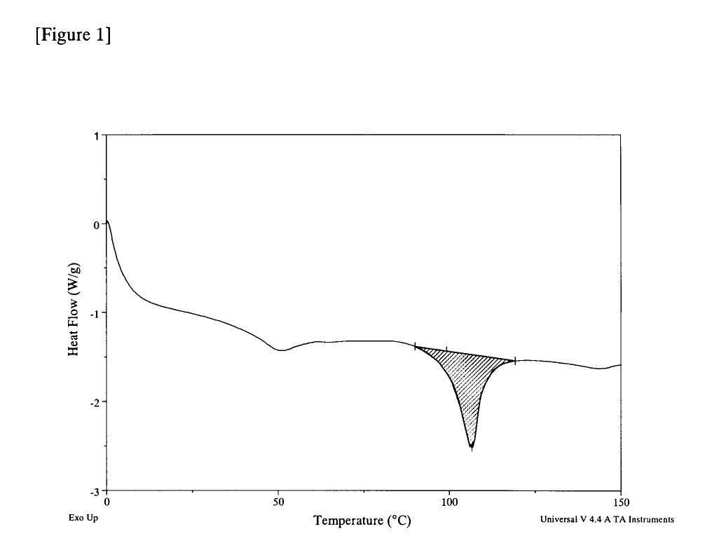

An example of the endothermic peak is shown in FIG. 1.

### [Volume-Median Particle Size (D₅₀) of Toner]

Measuring Apparatus: Coulter Multisizer II (commercially available from Beckman Coulter K.K.)
Aperture Diameter: 50 μm
Analyzing Software: Coulter Multisizer AccuComp Ver. 1.19 (commercially available from Beckman Coulter K.K.)
Electrolytic Solution: “Isotone II” (commercially available from Beckman Coulter K.K.)
Dispersion: “EMULGEN 109P” (commercially available from Kao Corporation, polyoxyethylene lauryl ether, HLB: 13.6) is dissolved in the above electrolytic solution so as to have a concentration of 5% by weight, to give a dispersion.
Dispersion Conditions: Ten milligrams of a test sample is added to 5 mL of the above dispersion, and the resulting mixture is dispersed in an ultrasonic disperser for 1 minute. Thereafter, 25 mL of the electrolytic solution is added thereto, and the resulting mixture is dispersed in the ultrasonic disperser for another 1 minute, to give a sample dispersion.
Measurement Conditions: The above sample dispersion is adjusted so as to have a concentration at which the particle sizes of 30,000 particles can be determined in 20 seconds by adding 100 mL of the above electrolytic solution to the above sample dispersion. Thereafter, the particle sizes of 30,000 particles are determined to obtain a volume-median particle size (D₅₀) from the particle size distribution.

### Preparation Example 1 of Crystalline Polyester

A 20-liter four-necked flask equipped with a nitrogen inlet tube, a dehydration tube, a stirrer and a thermocouple was charged with the raw material monomers as shown in Table 1 and 5.5 g of tertiary butyl catechol (TBC) (0.05 parts by weight, based on 100 parts by weight of the total amount of the α,ω-linear alkanediol and the aliphatic dicarboxylic acid compound), and the ingredients were reacted at 160° C. over a period of 5 hours. Thereafter, the resulting mixture was heated to 200° C., reacted for 1 hour, and further reacted at 8.3 kPa until a resin having a desired molecular weight was obtained, to give resins a, b, and c.

### Preparation Example 2 of Crystalline Polyester

A 5-liter four-necked flask equipped with a nitrogen inlet tube, a dehydration tube, a stirrer and a thermocouple was charged with the raw material monomers as shown in Table 1 and 2 g of hydroquinone (0.06 parts by weight, based on 100 parts by weight of the total amount of the α,ω-linear alkanediol and the aliphatic dicarboxylic acid compound), and the ingredients were reacted at 160° C. over a period of 5 hours. Thereafter, the resulting mixture was heated to 200° C., reacted for 1 hour, and further reacted at 8.3 kPa for 1 hour, to give a resin d.

### Preparation Example 3 of Crystalline Polyester

A 5-liter four-necked flask equipped with a nitrogen inlet tube, a dehydration tube, a stirrer and a thermocouple was charged with the raw material monomers as shown in Table 1, and the ingredients were reacted at 200° C. until granules of terephthalic acid were not observed. Thereafter, the resulting mixture was further reacted at 8.3 kPa for 3 hours, to give a resin e.

### Preparation Example 1 of Amorphous Polyester

A 20-liter four-necked flask equipped with a nitrogen inlet tube, a dehydration tube, a stirrer and a thermocouple was charged with the raw material monomers as shown in Table 1 and 20.5 g of tin octylate (0.2 parts by weight, based on 100 parts by weight of the total amount of the alcohol component and the carboxylic acid component), and the ingredients were reacted at 220° C. over a period of 8 hours. Thereafter, the resulting mixture was reacted at 8.3 kPa for 1 hour, and further reacted at 210° C. until a desired softening point was attained, to give a resin A.

### Preparation Example 2 of Amorphous Polyester

A 20-liter four-necked flask equipped with a nitrogen inlet tube, a dehydration tube, a stirrer and a thermocouple was charged with the raw material monomers except trimellitic anhydride as shown in Table 1 and 20.0 g of tin octylate (0.2 parts by weight, based on 100 parts by weight of the total amount of the alcohol component and the carboxylic acid component), and the ingredients were reacted at 220° C. over a period of 8 hours. Thereafter, the resulting mixture was reacted at 8.3 kPa for 1 hour. Further, trimellitic anhydride as shown in Table 1 was added thereto at 210° C., and the resulting mixture was reacted until a desired softening point was attained, to give a resin B.

### Preparation Example 3 of Amorphous Polyester

A 20-liter four-necked flask equipped with a nitrogen inlet tube, a dehydration tube, a stirrer and a thermocouple was charged with the raw material monomers except trimellitic anhydride as shown in Table 1 and 20.0 g of tin octylate (0.2 parts by weight, based on 100 parts by weight of the total amount of the alcohol component and the carboxylic acid component), and the ingredients were reacted at 220° C. over a period of 8 hours. Thereafter, the resulting mixture was reacted at 8.3 kPa for 1 hour. Further, trimellitic anhydride as shown in Table 1 was added thereto at 210° C., and the resulting mixture was reacted until a desired softening point was attained, to give a resin C.

TABLE 1

| | Crystalline Polyester | | | | | Amorphous Resin | | |
|---|---|---|---|---|---|---|---|---|
| | Resin a | Resin b | Resin c | Resin d | Resin e | Resin A | Resin B | Resin C |
| Raw Material Monomer | | | | | | | | |
| Alcohol Component | | | | | | | | |
| BPA-PO¹⁾ | — | — | — | — | — | 518 g (35) | 3391 g (50) | 4950 g (99) |
| BPA-EO²⁾ | — | — | — | — | — | 342 g (65) | 3148 g (50) | 50 g (1) |
| 1,4-Butanediol | — | — | — | 1215 g (90) | — | — | — | — |
| 1,6-Hexanediol | 5566 g (102) | 5566 g (102) | 5457 g (98) | 177 g (10) | 1416 g (98) | — | — | — |
| Carboxylic Acid Component | | | | | | | | |
| Fumaric Acid | 5635 g (100) | 5365 g (100) | 5472 g (100) | 1740 g (100) | — | — | — | 3614 g (73) |
| Terephthalic Acid | — | — | — | — | 1693 g (85) | 3412 g (100) | 2219 g (69) | 1337 g (27) |
| Dodecenylsuccinic Anhydride | — | — | — | — | — | — | 312 g (6) | — |
| Trimellitic Anhydride | — | — | — | — | — | — | 930 g (25) | 49.5 g (1) |
| Adipic Acid | — | — | — | — | 259 g (15) | — | — | — |
| Carboxylic Acid Component/ | 100/102 | 100/102 | 100/98 | 100/100 | 100/98 | 100/100 | 100/100 | 100/99 |
| Alcohol Component³⁾ | | | | | | | | |
| Physical Properties of Resin | | | | | | | | |
| Softening Point (° C.) | 117 | 115 | 111 | 122 | 117 | 112 | 124 | 110 |
| Acid Value (mgKOH/g) | — | — | — | — | — | 6 | 16 | 20 |
| Melting Point (° C.) | 110 | 111 | 112 | 125 | 120 | — | — | — |
| Glass Transition Temperature | — | — | — | — | — | — | — | — |
| (° C.) | | | | | | | | |
| Highest Temperature (° C.) | 110 | 111 | 112 | 125 | 120 | 64 | 68 | 62 |
| of Endothermic Peak | | | | | | | | |
| Softening Point/Highest | 1.06 | 1.04 | 0.99 | 0.98 | 0.98 | 1.75 | 1.82 | 1.77 |
| Temperature of Endothermic Peak | | | | | | | | |
| Number-Average Molecular | 6,300 | 8,900 | 2,600 | 3,700 | 3,400 | — | — | — |
| Weight (Mn) | | | | | | | | |
| Weight-Average Molecular | 53,000 | 112,000 | 9,500 | 10,500 | 12,500 | — | — | — |
| Weight (Mw) | | | | | | | | |
| Mw/Mn⁴⁾ | 8.4 | 12.6 | 3.7 | 2.8 | 3.7 | — | — | — |

Note)
The values for raw material monomers of the resins in parentheses are expressed as molar ratios when the total amount of the carboxylic acid component is defined as 100 moles.
¹⁾Polyoxypropylene(2.2)-2,2-bis(4-hydroxyphenyl)propane
²⁾Polyoxyethylene(2.0)-2,2-bis(4-hydroxyphenyl)propane
³⁾Molar ratio of carboxylic acid component to alcohol component (carboxylic acid component/alcohol component)
⁴⁾Ratio of weight-average molecular weight to number-average molecular weight (Mw/Mn)

### Examples 1 to 6

The resin binders of the kinds and the amounts as shown in Table 2, 3 parts by weight of a carnauba wax “Carnauba Wax C1” (commercially available from Kato Yoko), 0.06 parts by weight of a positively chargeable charge control agent “BONTRON P-51” (commercially available from Orient Chemical Co., Ltd.), 0.25 parts by weight of a negatively chargeable charge control agent “E304” (commercially available from Orient Chemical Co., Ltd.), and 4.5 parts by weight of a colorant “ECB-301” (Phthalocyanine Blue 15:3, commercially available from DAINICHISEIKA COLOR & CHEMICALS MFG. CO., LTD.) were previously mixed with a Henschel mixer. Thereafter, the mixture was melt-kneaded under the conditions shown below.

### [Example of Melt-Kneading Conditions: Open Roller]

An open-roller type kneader “Kneadex” (commercially available from MITSUI MINING COMPANY, LIMITED, outer diameter of roller: 140 cm, effective length of roller: 80 cm) was used for melt-kneading. The operating conditions of the continuous twin open-roller type kneader were a peripheral speed of a high-rotation side roller (front roller) of 9 m/min, a peripheral speed of a low-rotation side roller (back roller) of 6 m/min, and a gap between the rollers at the end part of a feeding port side for a kneaded product of 0.1 mm. The temperatures of the heating medium and the cooling medium inside the rollers were as follows. The high-rotation side roller had a temperature at the raw material supplying side of 135° C., and a temperature at the kneaded product discharging side of 90° C., and the low-rotation side roller had a temperature at the raw material supplying side of 35° C., and a temperature at the kneaded product discharging side of 35° C. In addition, the feeding rate of the raw material mixture was 4 kg/hour, and the average residence time was about 10 minutes.

The melt-kneaded product obtained above was rolled with a cooling roller, and cooled to a temperature of 20° C. or lower. Thereafter, the cooled product was heat-treated in an oven at a temperature and time as shown in Table 2.

The heat-treated product after the heat treatment was cooled and roughly pulverized, and thereafter pulverized and classified with a jet mill pulverizer and an airflow classifier (IDS, commercially available from Nippon Pneumatic Mfg. Co., Ltd.), to give toners of Examples 1 to 6 having a volume-median particle size (D₅₀) of 5.5 μm.

### Comparative Examples 1 to 7

The same procedures as in Example 1 were carried out using the resin binders of the kinds and the amounts as shown in Table 2, 3.5 parts by weight of a carnauba wax “Carnauba Wax C1” (commercially available from Kato Yoko), 2.5 parts by weight of a paraffin wax “HNP-9” (commercially available from NIPPON SEIRO CO., LTD.), 0.06 parts by weight of a positively chargeable charge control agent “BONTRON P-51” (commercially available from Orient Chemical Co., Ltd.), 0.25 parts by weight of a negatively chargeable charge control agent “E304” (commercially available from Orient Chemical Co., Ltd.), and 4.5 parts by weight of a colorant “ECB-301” (Phthalocyanine Blue 15:3, commercially available from DAINICHISEIKA COLOR & CHEMICALS MFG. CO., LTD.), to give toners of Comparative Examples 1 to 7 having a volume-median particle size (D₅₀) of 5.5 μm.

### Test Example 1

### Fixing Ability

A toner of Table 2 was loaded in a nonmagnetic monocomponent development device “OKI MICROLINE 5400” (commercially available from Oki Data Corporation), and image-printing was carried out as an unfixed image (printing area: 4.1 cm×13.0 cm, amount of toner adhesion: 0.45±0.03 mg/cm²). The resulting unfixed image was fixed on a sheet at a rate of 600 r/min using an external fixing device of “OKI MICROLINE 3010” (commercially available from Oki Data Corporation) (fixing speed: 300 mm/sec), while sequentially raising the fixing temperature from 90° to 240° C. in increments of 5° C. The generation of offset was visually observed, and the temperature range at which no offset was generated was examined. The results are shown in Table 2. Here, the sheets used for fixing were J paper commercially available from Fuji Xerox Office Supply Co., Ltd.

### Test Example 2

### Durability

A toner was loaded in an ID cartridge of a nonmagnetic monocomponent development device “OKI MICROLINE 5400” (commercially available from Oki Data Corporation), and the device was run idle at a rate of 70 r/min (corresponding to 36 ppm). The generation of uneven lines on the surface of a developing roller was visually observed, and the time until generation of uneven lines was determined. The results are shown in Table 2. Here, uneven lines refer to a state in which the variance in the amount of the toner adhered to the developing roller is generated. According to the generation of uneven lines, the shading in the image density is generated upon printing.

TABLE 2

| | Resin Binder | | | | | | | |
|---|---|---|---|---|---|---|---|---|
| | Crystalline Polyester | | Amorphous Resin | | | | | |
| | | Content in | | | | Aromatic | | |
| | | Resin | | | BPA | Carboxylic Acid | Heat Treatment | |
| | Constituent | Binder (% | | | Content¹⁾ | Compound | Temperature | Time |
| | Resin | by Wt.) (X) | Constituent Resin | | (% by mol) | Content²⁾ | (° C.) | (Hour) |
| Ex. 1 | Resin a (5) | 5 | Resin A (65) | Resin B (30) | 100 | 98.1 | 60 | 24 |
| Ex. 2 | Resin a (10) | 10 | Resin A (60) | Resin B (30) | 100 | 98.0 | 70 | 24 |
| Ex. 3 | Resin a (15) | 15 | Resin A (55) | Resin B (30) | 100 | 97.9 | 50 | 72 |
| Ex. 4 | Resin b (15) | 15 | Resin A (55) | Resin B (30) | 100 | 97.9 | 60 | 24 |
| Ex. 5 | Resin a (25) | 25 | Resin A (45) | Resin B (30) | 100 | 97.6 | 70 | 24 |
| Ex. 6 | Resin a (15) | 15 | Resin C (55) | Resin B (30) | 100 | 53.4 | 60 | 48 |
| Comp. | Resin c (15) | 15 | Resin A (55) | Resin B (30) | 100 | 97.9 | — | — |
| Ex. 1 | | | | | | | | |
| Comp. | Resin c (15) | 15 | Resin A (55) | Resin B (30) | 100 | 97.9 | 50 | 72 |
| Ex. 2 | | | | | | | | |
| Comp. | Resin c (15) | 15 | Resin A (55) | Resin B (30) | 100 | 97.9 | 70 | 2 |
| Ex. 3 | | | | | | | | |
| Comp. | Resin a (15) | 15 | Resin A (55) | Resin B (30) | 100 | 97.9 | — | — |
| Ex. 4 | | | | | | | | |
| Comp. | Resin a (15) | 15 | Resin C (55) | Resin B (30) | 100 | 51.1 | 70 | 24 |
| Ex. 5 | | | | | | | | |
| Comp. | Resin d (10) | 10 | Resin A (60) | Resin B (30) | 100 | 98.0 | 60 | 24 |
| Ex. 6 | | | | | | | | |
| Comp. | Resin e (10) | 10 | Resin A (60) | Resin B (30) | 100 | 98.0 | 60 | 24 |
| Ex. 7 | | | | | | | | |

| | | | Relationship Between Crystalline | | | | |
|---|---|---|---|---|---|---|---|
| | Crystallization Ratio | | Polyester Content and | | | Physical Properties of | |
| | (%) | | Crystallization Ratio of | | | Toner | |
| | | After Heat | Melt-Kneaded Product After | | | Fixing | |
| | Before Heat | Treatment | Heat Treatment³⁾ | | | Temperature | Durability |
| | Treatment | (Y) | 14/5 × X⁴⁾ | 16/5 × X⁴⁾ | 7/2 × X⁴⁾ | Range (° C.) | (Hour) |
| Ex. 1 | 7 | 18 | 14 | 16 | 17.5 | 150-200 | 6.0 |
| Ex. 2 | 18 | 70 | 28 | 32 | 35 | 140-195 | 6.0 |
| Ex. 3 | 32 | 57 | 42 | 48 | 52.5 | 135-190 | 7.0 |
| Ex. 4 | 32 | 64 | 42 | 48 | 52.5 | 135-190 | 4.0 |
| Ex. 5 | 67 | 75 | 70 | 80 | 87.5 | 120-180 | 4.5 |
| Ex. 6 | 5 | 54 | 42 | 48 | 52.5 | 120-185 | 3.5 |
| Comp. | 29 | — | 42 | 48 | 52.5 | 145-190 | 0.5 |
| Ex. 1 | | | | | | | |
| Comp. | 28 | 30 | 42 | 48 | 52.5 | 150-190 | 1.2 |
| Ex. 2 | | | | | | | |
| Comp. | 29 | 32 | 42 | 48 | 52.5 | 150-190 | 0.7 |
| Ex. 3 | | | | | | | |
| Comp. | 32 | — | 42 | 48 | 52.5 | 130-185 | 2.0 |
| Ex. 4 | | | | | | | |
| Comp. | 23 | 39 | 42 | 48 | 52.5 | 130-185 | 2.0 |
| Ex. 5 | | | | | | | |
| Comp. | 10 | 25 | 28 | 32 | 35 | 130-185 | 1.5 |
| Ex. 6 | | | | | | | |
| Comp. | 7 | 19 | 28 | 32 | 35 | 140-190 | 2.5 |
| Ex. 7 | | | | | | | |

Note)
The amounts of the resin binders are expressed in parts by weight.
¹⁾The content of an alkylene oxide adduct of bisphenol A in the alcohol component (% by mol) in the amorphous resin is shown.
²⁾The aromatic carboxylic acid compound content in the carboxylic acid component (% by mol) in the amorphous resin is shown.
³⁾The relation between the crystalline polyester content in the resin binder and the crystallization ratio of the melt-kneaded product after the heat treatment is shown.
⁴⁾X is the crystalline polyester content in the resin binder (% by wt.).

It can be seen that the toners of Examples 1 to 6 are excellent in durability, as compared to the toners of Comparative Examples 1 to 7. Especially, it can be seen that the toner of Example 3 is excellent in durability, as compared to the toner of Comparative Example 4 which has the same composition of resin binders but not heat-treated. In addition, it can be seen that even when a toner in which the crystalline polyester content in the resin binder is low and the crystallization ratio of the melt-kneaded product before a heat treatment is low, such as the toner of Example 1, once the toner has a certain crystallization ratio by the heat treatment, the toner is excellent in durability. On the other hand, the toners of Comparative Examples 1 to 3 contain the crystalline polyester having a small number-average molecular weight of 2,600 and a small weight-average molecular weight of 9,500. Therefore, it is presumed that even if the crystallization ratio is increased by the heat treatment, any of the toners have narrow fixing temperature ranges and result in poor durability.

The toner for electrostatic image development obtained by the present invention is suitably used for, for example, developing a latent image formed in electrophotography, electrostatic recording method, electrostatic printing method, or the like.

The present invention being thus described, it will be obvious that the same may be varied in ways. Such variations are not to be regarded as a departure from the spirit and scope of the invention, and all such modifications as would be obvious to one skilled in the art are intended to be included within the scope of the following claims.

What is claimed is:

1. A method for producing a toner for electrostatic image development, comprising the steps of melt-kneading a resin binder comprising a crystalline polyester and an amorphous resin as main components, and heat-treating the melt-kneaded product obtained in the step of melt-kneading at a temperature of from 50° to 80° C., wherein the crystalline polyester satisfies the following (A) to (C):
(A) the crystalline polyester has
a number-average molecular weight (Mn) of from 5,000 to 10,000,
a weight-average molecular weight (Mw) of from 40,000 to 150,000,
a highest temperature of endothermic peak determined with a differential scanning calorimeter of from 100° to 140° C., and
a ratio of the softening point to the highest temperature of endothermic peak, i.e., softening point/highest temperature of endothermic peak, of from 0.8 to 1.2,
(B) the crystalline polyester is contained in an amount of from 1 to 35% by weight of the resin binder, and
(C) the crystalline polyester is a polycondensed product of an α,ω-linear alkanediol and an aliphatic dicarboxylic acid compound.

2. The method according to claim 1, wherein the crystalline polyester has a ratio of the weight-average molecular weight (Mw) to the number-average molecular weight (Mn), i.e., Mw/Mn, of from 5 to 20.

3. The method according to claim 1, wherein the amorphous resin is a polyester obtained by polycondensation of an alcohol component comprising an alkylene oxide adduct of bisphenol A in an amount of 90 to 100% by mol and a carboxylic acid component comprising an aromatic carboxylic acid compound in an amount of 90 to 100% by mol.

4. The method according to claim 1, wherein the amorphous resin comprised two different kinds of amorphous polyesters of which softening points differ by 10° C. or more.

5. The method according to claim 1, wherein the step of heat-treating is carried out at a temperature of from 50° to 80° C. for 3 to 80 hours.

6. The method according to claim 1, wherein the step of heat-treating comprises the steps of once cooling the melt-kneaded product after the step of melt-kneading to a pulverizable hardness, and thereafter heat-treating the cooled melt-kneaded product.

7. The method according to claim 1, further comprising the step of pulverizing the heat-treated product obtained in the step of heat-treating.

8. A toner for electrostatic image development obtained by the method as defined in any one of claims 1 to 7.
